(19) United States
(12) Patent Application Publication
(10) Pub. No.: US 2011/0268917 A1
(43) Pub. Date: Nov. 3, 2011

(54) STONE COMPONENT ASSEMBLY SYSTEM

(76) Inventor: Shaofeng Wang, Salt Lake City, UT (US)

(21) Appl. No.: 12/771,965

(22) Filed: Apr. 30, 2010

(51) Int. Cl. B32B 7/00; B32B 21/04; B32B 5/00; B23P 11/00

(52) U.S. Cl. 428/119; 29/428; 428/452; 428/221; 428/332

(57) ABSTRACT

A furniture system may be provided so that stone components may be more easily assembled and installed. The furniture system may comprise a piece of stone and a piece of wood attached to a side of the piece of stone.

### BACKGROUND OF THE INVENTION

The present invention generally relates to a stone component assembly system, and more specifically relates to stone components of furniture having wood attached to one side that may be more easily assembled and installed.

Currently, stone materials, such as granite, quartz, and marble are popular materials for use as countertops in the kitchen, in the bathroom, and throughout houses and hotels.

However, these stone materials are often difficult to assemble and install. Typically, a wood or metal frame system may need to be built by a professional installer during the installation to receive a stone countertop on top of the frame system. However, building and using such a frame system may be expensive and increase the chances that the countertop installation might not finish on schedule.

As can be seen, there is a need for a way to more easily assemble and install stone materials.

### SUMMARY OF THE INVENTION

In one aspect of the present invention, a furniture system may comprise a piece of stone; and a piece of wood attached to a side of the piece of stone.

In another aspect of the present invention, a method for constructing furniture may comprise disposing a first piece of stone and a second piece of stone perpendicularly from each other, the first piece of stone having a first piece of wood attached to a side of the first piece of stone, and the second piece of stone having a second piece of wood attached to a side of the second piece of stone; and attaching a corner bracket to the first piece of wood and the second piece of wood to attach the first piece of stone to the second piece of stone.

These and other features, aspects and advantages of the present invention will become better understood with reference to the following drawings, description and claims.

### BRIEF DESCRIPTION OF THE DRAWINGS

FIG. 1 shows a perspective view of a vanity, and a shelf in accordance with an embodiment of the present invention;

FIG. 2 shows a partial exploded view of the vanity and the shelf of FIG. 1;

FIG. 3 shows an exploded view of the vanity and the shelf of FIG. 1;

FIG. 4 shows a plan view of the vanity and the shelf of FIG. 1;

FIG. 5 shows a front elevation view of the vanity and the shelf of FIG. 1;

FIG. 6 shows a side elevation view of the vanity and the shelf of FIG. 1;

FIG. 7 shows a partial plan view of the vanity of FIG. 1; and

FIG. 8 shows another partial plan view of the vanity of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide ways to more easily and quickly assemble and install stone materials as part of a vanity or other furniture.

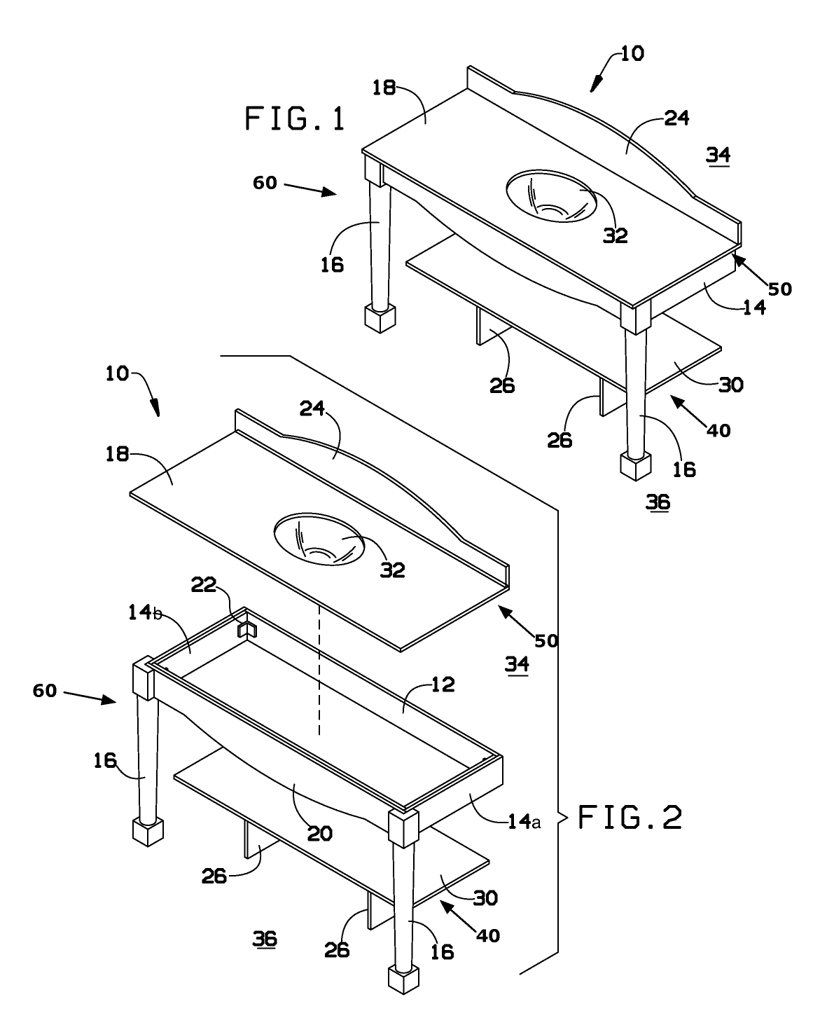

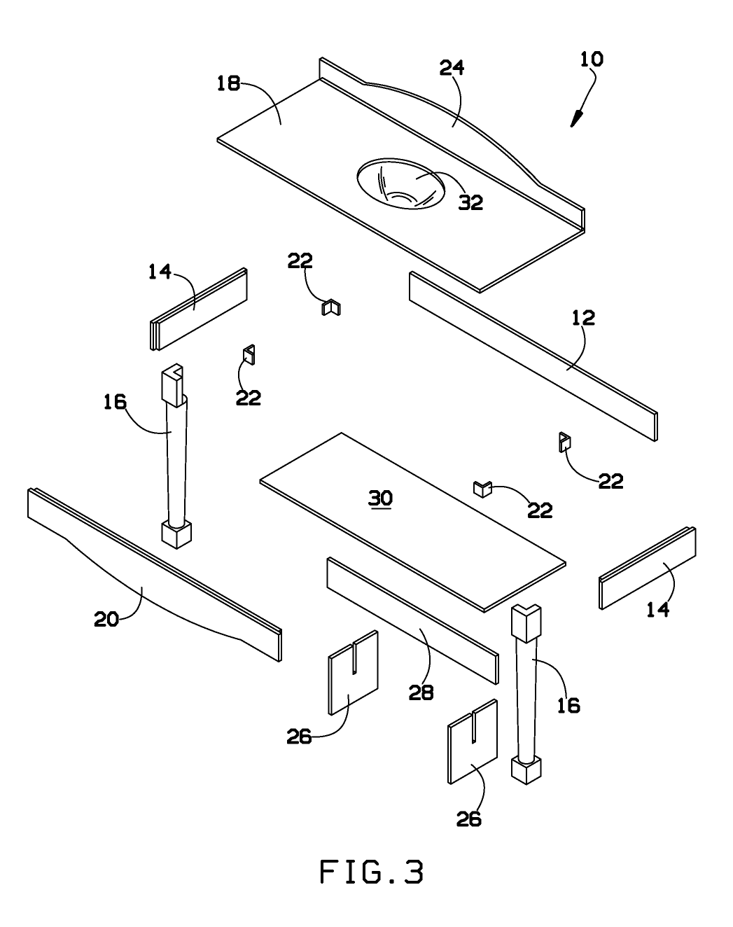

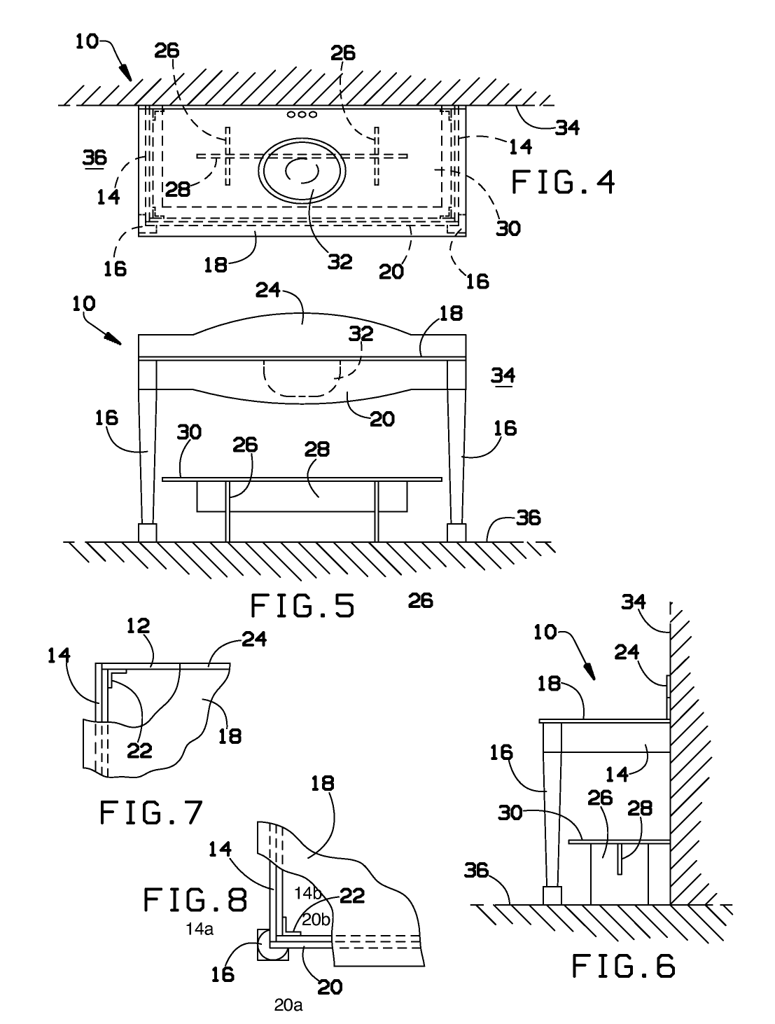

With reference to FIGS. 1-8, embodiments of the present invention may comprise a shelf 40, a countertop 50, and a base 60 to form a completed vanity 10.

A countertop 50 may comprise a countertop surface 18. Further, a backsplash 24 and a cutout 32 for fitting a sink may also be part of the countertop 50. The countertop surface 18 may be made of a hard stone material, such as granite, quartz, or marble, or may be made out of any other suitable material such as metal, wood, or other stone materials. The backsplash 24 may be situated so that it contacts a wall 34 and may be made of the same materials as the countertop surface 18, although the backsplash 24 may also be made of any other suitable materials.

The base 60 may be kitchen cabinets, vanities, table bases, or any other suitable pieces of furniture. One or more legs 16 may contact the ground 36 and may support an upper base comprising a front apron 20, a back wall cleat 12, and side aprons 14 that may be connected via corner braces 22 to form a rectangular area upon which to accept the countertop 50 onto the base 60.

The side aprons 14 and the front apron 20 may be a piece of stone, such as a rectangular slab of granite, marble, cultured marble corian, or other stone, engineered stone-looking plastic, stone product, or cement product, having a piece of wood attached to at least a portion of one side of the piece of stone, so that the side aprons 14 may each have a stone side 14a and a wood side 14b while the front apron 20 may also have a stone side 20a and a wood side 20b. The wood sides 14b and 20b may be of a rectangular shape, and may be attached to the side aprons 14 and the front aprons 20 respectively via glue or any other suitable methods of attachment. In an exemplary embodiment, the wood sides 14b and 20b may be about ¾ inches thick, or may be of any other appropriate thickness. The corner braces 22 may be galvanized L brackets that may be screwed into wood via #8×¾-inch screws.

To assemble the vanity 10, the one or more legs 16 may be placed on the floor 36. Alternatively, instead of the legs 16, the side aprons 14 and/or the front apron 20 may extend to the floor and act as legs or supports for the vanity 10. The back wall cleat 12 may be made of wood, and may be attached to the wall 34, such as by screwing the back wall cleat 12 to the wall 34. Side aprons 14 may be placed between each of the legs 16 and the back wall cleat 12 and may be secured to the back wall cleat 12 via corner braces 22 screwed into the wood side 14b of the side apron 14 and the back wall cleat 12. The side aprons 14 may be secured to the legs 14 via silicone or any other appropriate adhesive.

The front apron 20 may be placed between the legs 16 so that it may be situated perpendicularly to the side aprons 14, and may be secured to the side aprons 14 via corner braces 22 that may be screwed into the wood side 20b of the front apron 20 and the wood side 14b of the side aprons 14. The front apron 20 may be secured to the legs 14 via silicone or any other appropriate adhesive. Silicone may also be used to seal any joints on the countertop 50, the base 60, or between any other components, in order to ensure a watertight fit.

The countertop surface 18 may be placed on top of the base 60 and may be secured to the base 60 via silicone or any other adhesive. The backsplash 24 may also be secured to the wall 34 via silicone or any other adhesive.

The shelf 40 may comprise a shelf surface 30, shelf legs 26, and a shelf reinforcement beam 28. The shelf surface 30 may be a flat slab that may be of a suitable size and shape. For example, the shelf surface 30 may be of a rectangular shape. The shelf legs 26 may be placed in order to evenly support the shelf surface 30. For example, the shelf 40 may comprise a pair of shelf legs 26 that are equidistant from the end of the shelf surface 30. The shelf reinforcement beam 28 may run down the middle and along a portion of the length of the bottom of the shelf surface 30. The shelf reinforcement beam 28 may help to reinforce the shelf surface 30.

To assemble the shelf 40, a large rectangular piece of material, such as granite or other stone material, may be used as the shelf surface 30. The shelf reinforcement beam 28 may be affixed to the shelf surface 30, such as via silicone or any other suitable adhesive. A pair of shelf legs 26 may then be affixed both to the shelf surface 30 and/or the shelf reinforcement beam 28, such as via silicone or any other appropriate adhesive.

It should be understood, of course, that the foregoing relates to exemplary embodiments of the invention and that modifications may be made without departing from the spirit and scope of the invention as set forth in the following claims.

We claim:

1. A furniture system comprising:
a piece of stone; and
a piece of wood attached to a side of the piece of stone.

2. The system of claim 1, wherein:
the piece of stone is a rectangular slab of stone; and
the piece of wood is a rectangular slab of wood.

3. The system of claim 1, wherein the piece of wood is about ¾ inch thick.

4. The system of claim 1 further comprising:
a second piece of stone situated perpendicularly to the piece of stone;
a second piece of wood attached to a side of the second piece of stone; and
a corner bracket that perpendicularly connects the piece of stone and the second piece of stone.

5. The system of claim 4, wherein:
the corner bracket is an L bracket; and
the corner bracket is screwed into the piece of wood and the second piece of wood.

6. A method for constructing furniture, comprising:
disposing a first piece of stone and a second piece of stone perpendicularly from each other, the first piece of stone having a first piece of wood attached to a side of the first piece of stone, and the second piece of stone having a second piece of wood attached to a side of the second piece of stone; and
attaching a corner bracket to the first piece of wood and the second piece of wood to attach the first piece of stone to the second piece of stone.

7. The method of claim 6, wherein the attaching further comprises screwing the corner bracket to the first piece of wood and the second piece of wood.

8. The method of claim 6, further comprising:
disposing a third piece of stone perpendicular to the second piece of stone and parallel to the first piece of stone, the third piece of stone having a third piece of wood attached to a side of the third piece of stone; and
attaching a second corner bracket to the second piece of wood and the third piece of wood to attach the second piece of stone to the third piece of stone.

9. The method of claim 8, further comprising:
attaching a third corner bracket to the first piece of wood and a back wall cleat to attach the first piece of stone to the back wall cleat; and
attaching a fourth corner bracket to the third piece of wood and the back wall cleat to attach the third piece of stone to the back wall cleat;
wherein the back wall cleat is parallel to the second piece of stone.

10. The method of claim 9, further comprising:
placing a countertop surface on top of the first piece of stone, the second piece of stone, and the third piece of stone.
